(19) United States
(12) Patent Application Publication
(10) Pub. No.: US 2007/0014992 A1
(43) Pub. Date: Jan. 18, 2007

(54) Scented multilayer films and method of making

(76) Inventor: Kenneth Joesph Longmoore, Newark, DE (US)

Correspondence Address: POTTER ANDERSON & CORROON LLP;ATTN: KATHLEEN W. GEIGER, ESQ., P.O. BOX 951, WILMINGTON, DE, 19899-0951, US

(21) Appl. No.: 11/182,896

(22) Filed: Jul. 15, 2005

(51) Int. Cl. B32B 27/34; B32B 27/36; B32B 27/32; B32B 27/18

(52) U.S. Cl. 428/411.1; 428/523; 428/500; 428/480; 428/521; 428/474.4; 428/910; 156/326

(57) ABSTRACT

This invention relates to flexible packaging materials based on multi-layered films. Specifically, it relates to multi-layered flexible packaging films wherein the individual films or webs are bonded to each other through an adhesive layer. More specifically, the invention relates to such flexible packaging materials that have at least one aroma embedded within at least one adhesive layer, and wherein the two films on either side of the aroma-embedded adhesive layer may have different permeation characteristics to the aroma. Thus, this invention relates to multi-layered film-based flexible packaging materials with enhanced aroma characteristics. Finally, this invention also relates to a process for making such flexible packaging materials.

### FIELD OF THE INVENTION

This invention relates to flexible packaging materials based on multi-layered films. Specifically, it relates to multi-layered flexible packaging films wherein the individual films or webs are bonded to each other through an adhesive layer. More specifically, the invention relates to such flexible packaging materials that have at least one aroma embedded within at least one adhesive layer, and wherein the two films on either side of the aroma-embedded adhesive layer may have different permeation characteristics to the aroma. Thus, this invention relates to multi-layered film based flexible packaging materials with enhanced aroma characteristics. Finally, this invention also relates to a process for making such flexible packaging materials.

### BACKGROUND

Devices designed to release vapor or liquids from compounds have been in wide use. For example air freshener devices, perfume product samples as magazine inserts, and perfume patches or pads that provide a short-term pleasant odor are known. Many of the release devices have the fragrance microencapsulated in one of the layers. The fragrance is released when the microcapsules break as a result of friction, pressure, etc.

Because force is required to release the fragrance, a structure that has fragrance encapsulated in a microcapsule may not consistently provide fragrance if it does not undergo force sufficient to break at least some of the microcapsules. For example, flexible packaging materials used for food products such as snacks, candy bars, granola bars, cereals, etc., may not undergo sufficient force to release fragrance from such microcapsules. Further, in applications where the area available for incorporating microcapsules is not sufficient, for example, in packages where the microcapsules are incorporated only in the seal portion of the package, sufficient amount of fragrance may not be released. Clearly, an alternative method for releasing fragrance that takes into consideration the lack of force for releasing the fragrance can be advantageously utilized.

The present invention addresses both of these problems. It relates to a flexible packaging material capable of releasing desired aroma from within the laminated structure of the packaging material in a desired direction. Such a structure has at least two films. The aroma is embedded in the adhesive layer in between any two films or webs. The aroma diffuses through either one or both of the films and depending upon the permeability of a given aroma to a given film, the direction of diffusion of the aroma can be controlled in a desired manner. Because the application of the present invention is in flexible packaging materials where the force of friction may not be adequate to release the aroma, if the aroma was microencapsulated, the inventors of the present invention have demonstrated a novel method of incorporating the aroma in the packaging material by impregnating the aroma in the adhesive layer or layers of the laminated structure and preparing the laminated structure capable of releasing the aroma in a desired direction. A larger “reservoir” of aroma, embedded within the adhesive layer is now available. Substantially, the entire surface area of the film packaging material is now available to release the aroma.

Furthermore, the present invention teaches that the aroma resides in the adhesive layer. Because the aroma is embedded in the adhesive and not in the film or the web of the laminated structure, the aroma does not get exposed to the thermal history that the primary and the secondary webs get exposed to during the film forming process. Therefore, loss of the aroma as a result of evaporation is reduced. Moreover, if the aroma were incorporated into the film or the web, the degradation residue of the aroma could provide an undesirable odor. This problem is eliminated by the present invention because the aroma is embedded in the adhesive.

U.S. Pat. No. 5,071,704 does not use a microencapsulated structure to release the fragrance and describes a laminated device that releases fragrance in a controlled manner. Such a device is used as an air-freshener. Such a device requires a 50 μm thick decorative polyester layer, a diffusion rate-limiting layer necessarily made of 40 μm thick ethylene vinyl acetate adjacent to the polyester layer, a reservoir layer having a gelled mixture of perfume and hydroxypropyl cellulose, and a backing layer necessarily made of 50 μm of medium-density polyethylene, aluminized polyester or ethylene vinyl acetate. The backing layer, on the outside consists of a medical grade silicone adhesive that can adhere to wall surface, skin, clothing, etc.

U.S. Pat. Pub. No. 2003/0077470 discloses a laminated board product made from paper. The laminated board product is used for making containers for carrying canned or bottled beverages or for various folding carton applications. The laminated board product is repulpable and recyclable. It has a board substrate, a coated or an uncoated paper laminated on the board substrate and optionally a pigmented opaque polymer film, coated on the other side of the board substrate. An ink-jet coating layer can also be added for ink-jet printing applications. The paper is laminated by a standard adhesive lamination including aqueous-based, solvent-based, or UV-cured lamination; pasting methods; by extrusion lamination; or through a hot-melt application system. The publication mentions that the finished carton can be imparted attractive odor by adding a chemical fragrant to the adhesive, or by spraying moisturization water with fragrance on to the carton.

Further, U.S. Pat. No. 4,874,129 discloses a multi-laminate fragrance release device that can be attached to household and industrial substrates or to the human skin. The device of this patent is a multi-layered structure having a first layer of a pressure sensitive adhesive release liner for providing a protective peel strip for the device, a second layer of silicone pressure sensitive adhesive or other suitable pressure sensitive adhesive that affixes the device to a substrate, including human skin, a third layer of a fragrance oil-impregnated matrix of a silicone material selected from the group consisting of silicone elastomers or silicone elastomers having adhesive characteristics, and elastomeric silicone pressure sensitive adhesives, and a fourth layer of permeable facestock backing member on the surface of the device for controlling the rate of release of the fragrance oil from the impregnated matrix.

The packaging material of the present invention is flexible. It can be used in packaging for items such as foods, beverages, personal care items, health-care items, animal food, and electronic and medical equipment. It is noted that these uses are listed for illustration purposes only. The packaging material can easily be extended to other uses.

### SUMMARY OF INVENTION

The present invention relates to a laminated structure used for flexible packaging material, comprising:
(a) a first web;
(b) a second web; and
(c) an adhesive layer positioned between and in contact with said first web and said second web, said adhesive layer comprising a bonding material and at least one aroma generating substance;
   wherein said first web's permeability of said aroma generating substance is greater than said second web's permeability of said aroma generating substance.

This invention also relates to a process for preparing a flexible packaging material capable of releasing aroma, comprising:
(a) providing a first web;
(b) providing a second web; and
(c) providing an adhesive layer positioned between and in contact with said first web and said second web, said adhesive layer comprising a bonding material and at least one aroma generating substance;
   wherein said first web's permeability of said aroma generating substance is greater than said second web's permeability of said aroma generating substance.

### BRIEF DESCRIPTION OF DRAWINGS

FIG. 1: FIG. 1 depicts a typical laminated structure with an outside web, an inside web and an adhesive layer between the two webs.

FIG. 2: FIG. 2 depicts a laminated structure with an outside web, an inside web and a multilayered adhesive layer between the two webs.

### DETAILED DESCRIPTION OF THE INVENTION

By a “web” is meant one or more of individual film layers. Generally, several film layers form a web. A film layer is that individual layer, which is made substantially of same type of material. An individual film layer can be polymeric or otherwise, for example, metallic foil, metallized film, metallic organic polymer, paper layer or metallized paper layer.

A web may be alternatively called a “film” throughout this patent application. A “web” or a “film” mean one and the same for this patent application.

By a “laminated structure” is meant a plurality of webs stacked adjacent to each other. Generally, a typical laminated structure comprises an outside web and an inside web with an adhesive layer positioned in between the outside web and the inside web. Generally, the inside web is the film that comes in contact with the items to be packaged. The inside web or the outside web can have polymeric or plastic film layers, and/or paper film layers, and/or metal-coated film layers, and/or film layers described as above.

Generally and in one aspect of the present invention, the outside web or the inside web comprises three individual film layers—an inner film layer, a core film layer and an outer film layer. The inner film layer is generally adjacent to the adhesive layer. The inner film layer or the outer film layers are alternatively referred to as “skin” in this application.

By “adhesive layer” is meant a layer comprising at least one type of bonding material that bonds two webs in the laminated structure. Such adhesive layer may further comprise an aroma generating substance. At least one adhesive layer in the laminated structure comprises an aroma generating substance. An adhesive layer is generally positioned between the outside web and the inside web. The adhesive layer can also comprise two or more individual layers of different types of adhesives. If any two individual adhesive layers are in contact with each other, then they are substantially different from each other, and/or have different aroma generating substance embedded in it. The adhesive layer is generally continuous within the configuration described here. However, the adhesive layer can also be discontinuous in that it adheres to a film or another adhesive layer in discontinuous manner, for example a pattern of discrete spots of the adhesive, or any other discrete pattern of the adhesive.

By a “metal-coating” is meant a coating comprising a metallic component; the metal coating is applied by a deposition process such as sputtering, vacuum vapor deposition and plasma treatment. In one embodiment, the metal component is in form of metal oxide. Examples of such metal oxide include silicon oxide and aluminum oxide. Such a metal-coating also includes a metallic foil. The metallic foil can be an individual film layer as a component of a web, or it can be the web itself. In this latter case, what is meant is that the web comprises only one layer, i.e., metallic foil.

By an “aroma” is meant any odor, whether it is a fragrance or a flavor that can generally stimulate olfactory senses of living beings. Although this application relates to aroma that are detectable by living beings, the application clearly envisions a use of this invention wherein said “aroma” is either odorless or below the detection limits of the olfactory senses of the subject living being in question, but may have some advantageous or disadvantageous end result for the subject living being . . . For example, this invention does encompass an application wherein said “aroma” is either odorless and/or is not detectable by, for example, humans, but the release of which affects the growth of microbes. Such an application of the present invention is fully envisioned by the specification herein.

By an “aroma generating substance” is meant a substance that is incorporated within an adhesive layer and has a particular type of fragrance or flavor. Two or more aroma generating substances can be incorporated within an adhesive layer. The aroma can be present as directly incorporated into the adhesive or can be present as a component of an additive to the adhesive layer.

Packaging Material

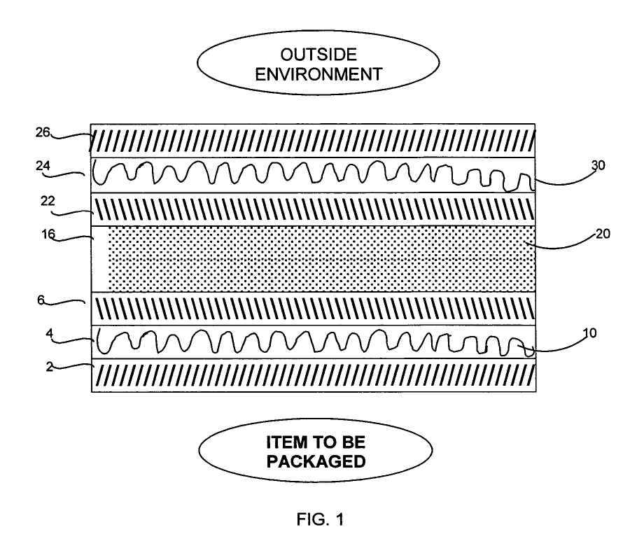

A typical packaging material or a laminated structure is described in FIG. 1. The inside web 10 adheres to the outside web 30 through an adhesive layer 20.

The inside web comprises of an outer layer or outer skin 2, a core layer 4, and an inner layer or inner skin 6. The outer layer 2 generally comes in contact with the item to be packaged.

The outside web comprises of an outer layer or outer skin 26, a core layer 24, and an inner layer or inner skin 22. The outer layer 26 generally is exposed to the outside environment, or in other words, is away from the item to be packaged.

The adhesive layer 20 is positioned in between the inside web 10 and the outside web 30.

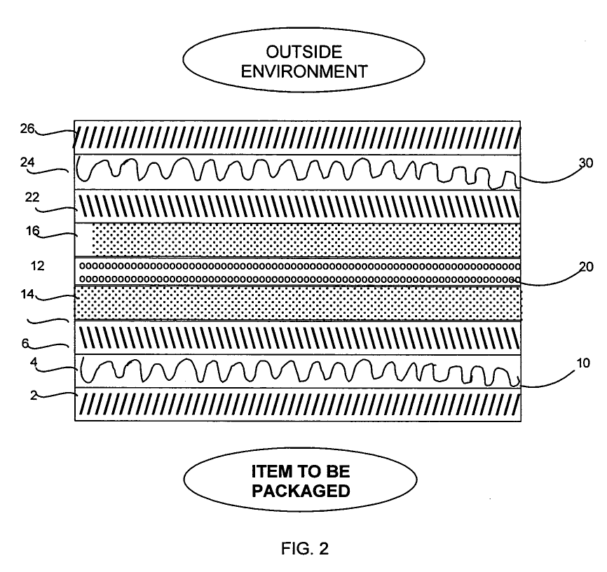

In one embodiment, the adhesive layer may include multiple layers, for example co-extruded adhesives. As shown in FIG. 2, the adhesive layer 20 has a polyethylene core 12, and two tie-layers of polyethylene extrusion laminates, 14 and 16. The rest of the configuration, i.e., the inside web and the outside web of the laminated structure is the same as that shown in FIG. 1.

In one embodiment, the inside web or the outside web can be a plurality of individual film layers. An individual film layer can be a polymeric layer, a paper layer, a vacuum-metallized coated polymeric film layer, plasma-coated polymeric film layer, a vacuum-metallized coated paper layer, or a plasma-coated paper layer.

Polymers that can be used for such film layers are for example, and not limited to, polypropylene, polyethylene, polybutylene, copolymers of propylene with ethylene and/or butene-1, butene-1 with ethylene, copolymers of propylene with butene-1, copolymers of ethylene and butylene, terpolymers of propylene-ethylene-butylene, cyclic olefins, styrene-butadiene copolymer, polystyrene, polyester, polyamide, ionomers, and other such film-forming polymers. Such film-forming polymers are well-known to the person skilled in the pertinent art.

Polypropylene

Preferred polymer for this application is the homopolymer of polypropylene or a heteropolymer of polypropylene.

Any isotactic polypropylene can be employed in the manufacture of films according to the invention. Isotactic polypropylene with an isotactic index in the range of from about 90% to about 98% is preferred. Suitable and preferred polypropylenes include high tacticity polypropylene. This material, available under several trade names, is defined as having an isotactic index of at least 93%, and preferably at least about 96%. Typical high tacticity polypropylene is further characterized by higher stiffness, greater surface hardness, lower heat deflection at high temperatures, lower heat shrinkage and better creep properties than conventional isotactic polypropylenes, which have isotactic index generally less than 93%. Typical high-crystallinity polypropylenes that can be employed include ACCPRO 9117, ACCPRO 9119 and ACCPRO 9218 (all available from Amoco Polymers, Alpharetta, Ga.).

Another polypropylene composition can be prepared by blending conventional commercial isotactic polypropylene prepared via Ziegler-Natta catalysis with a polypropylene prepared by use of a metallocene catalyst.

Another species of high modulus polypropylene that can be employed in the films of the invention is nucleated polypropylene. These are conventional polypropylenes that have been nucleated to increase their crystallinity level and which exhibit higher modulus as a result.

By “heteropolymer” is meant an olefin polymer containing propylene and at least one other alpha-monoolefin. The materials found useful in the practice of this invention have melting points lower than that of polypropylene and a density no greater than about 0.95 g/cm³ and preferably between 0.91 and 0.95 g/cm³. By “alpha-monoolefin” is meant a linear hydrocarbon having one carbon-carbon double bond; the said double bond is located at the end of the linear chain. The term is intended to include any such monomer having 6 carbon atoms or less, including ethylene and propylene.

Typical of such heteropolymers are ethylene-propylene copolymers having about 4.5 to 6% by weight of ethylene, butene-propylene copolymers containing about 5 to 34% by weight of butene-1 and ethylene-propylene-butene-1 terpolymers. Exemplary commercially available heteropolymers that can be employed in the practice of the invention include Fina 8573, Fina Z9470 (AtoFina Chemical Co., Houston, Tex.) and Sumitomo SP88E5 (Sumitomo Chemical Company, Tokyo, Japan).

By “low density polyethylene” is meant a polyethylene species having a density less than about 0.935 g/cm³ and preferably between about 0.915 g/cm³ and 0.935 g/cm³. By contrast, high-density polyethylene, widely used in the film art for preparing polyethylene film, has a density on the order of 0.95-0.97 g/cm³. Low-density polyethylenes are known, commercially available materials. Typical of commercially known low-density polyethylenes are Chevron 1017 (Chevron Chemicals, Houston, Tex.), Exxon Exact 3132 (Exxon Chemicals, Houston, Tex.), and Petrothene NA321 (Quantum Chemical, Chicago, Ill.). These polymers can be ethylene homopolymers or they can be copolymers of ethylene with a linear .alpha.-monoolefin having 4 to 8 carbon atoms in which the ethylene predominates. Such copolymers are also referred to in the art as low-density polyethylenes.

The Adhesive

The laminating adhesive, i.e., the adhesive layer comprises of extrusion laminating adhesive such as LDPE or conventional adhesives such as acrylics, urethanes, and acrylates. Aroma is embedded in the adhesive layer. More than one aroma can also be embedded in the adhesive layer.

The adhesive layer can comprise of a plurality of layers. If the adhesive layer comprises a plurality of layers, then each layer is different from other adhesive layers immediately adjacent to the said layer, or each layer has a different aroma embedded in it, or each layer is different from other adhesive layers immediately adjacent to the said layer and each layer has a different aroma embedded in it. In one embodiment, LDPE extrudate is used as an adhesive to increase the stiffness of the flexible package. For example, such extrusion laminating adhesives are commonly used in snack food bags, e.g., potato chips, corn chips and pretzels.

In another embodiment conventional adhesives such as acrylics, urethanes, and acrylates are used in the adhesive layer. The conventional adhesives are used for example in candy bar or cereal bar wrappers, where the additional stiffness may not be required.

Generally and preferably, the extrusion laminating adhesive layer comprises polyethylene. The aroma generating substance, or the aroma is necessarily embedded or present in this layer, at least at the time of formation of the composite structure. Subsequently, the aroma can diffuse or permeate through at least one film or web.

Further preferred adhesives include maleic anhydride modified ethylene-vinyl acetate, such as Bynel R™ E418 adhesive resin available from DuPont, and Escor R™ ATX 325 acid terpolymer available from Exxon Chemical, which is an ethylene-based resin having both ester and acrylic acid functionality.

A more preferred adhesive layer may comprise a copolymer of ethylene with an ester, an ethylene/vinyl acetate copolymer, or an ethylene/methyl acrylate copolymer, an ethylene/n-butyl acrylate copolymer, or an ethylene/ethyl acrylate copolymer. Ionomers (partially hydrolyzed ester derivatives) are also useful adhesives. Alternatively, the adhesive layer may comprise a grafted polyolefin adhesive, such as a polyethylene or polypropylene backbone grafted with at least one ethylenically unsaturated carboxylic acid, carboxylic acid anhydride, or other derivative, as known in the art.

It should be noted that where side reactions are possible, reactive functionalities on some polymers might limit the choice of aromas used. A person of ordinary skill in the pertinent art is familiar with such side reactions and phenomena.

In one embodiment, the inside web is a barrier layer. Because it is a barrier layer, only an insubstantial or limited amount of aroma can diffuse through the web. It is also envisioned that almost no aroma can diffuse through the barrier web. What is meant by “no aroma can diffuse through the web” is that the diffusion is so limited that it cannot be detected with ordinary scientific equipment. The barrier layer can be polymeric, metallized, or even a substrate. The barrier layer can also be a metal foil, coated paper or any other substrate.

The web may be just a polypropylene core film layer or may comprise a core film layer of a polypropylene with a skin layer on one or both sides of the core film layer. The skin layer may comprise a polypropylene copolymer or terpolymer or an ethylene polymer, co-extruded with the polypropylene core film layer. In one embodiment, the core layer may be a solid layer or a voided layer. A voided layer can be prepared by methods well known in the film art. The thickness of the total web is limited only by the tenter or the tubular process, which is typically about 12 microns to about 50 microns. The thickness of an individual co-extruded skin film layer is typically about 0.5 micron to about 2 microns.

In a preferred embodiment, the inside or the outside web comprise/s polypropylene. In another preferred embodiment, the polypropylene is cast polypropylene, blown polypropylene, uniaxially oriented polypropylene, biaxially oriented polypropylene, or a combination thereof. In a more preferred structure, the first film sheet and/or the second film sheet comprise/s-oriented polypropylene. In a further preferred structure, the first film sheet and/or the second film sheet comprise biaxially-oriented polypropylene.

In another embodiment, at least two aromas are embedded in two different adhesive layers within the multi-layered adhesive. In such structure, the second aroma takes a longer time to diffuse out into the environment. The structure can be constructed such that the second aroma appears coinciding with the likelihood of the product inside the packaging becoming inedible for consumption. For example, in food packaging, once the second aroma becomes predominant, a consumer, without having to taste the food inside or determining from the date of manufacture can smell the package and discard it.

Specifically, the present invention teaches that the aroma resides in the adhesive layer, which does not experience the thermal history of the outside or the inside web. Therefore, the likelihood of the aroma molecules remaining intact and not evaporating and/or not degrading during formation of the laminated structure (the packaging material) is high. The aroma molecules have differing permeability for the two webs. Also, one of webs can be impermeable to the aroma molecules such that the permeability and diffusion are very insubstantial or limited. One useful aroma molecule is d-limonene. In addition, the fragrances listed in Table 1 can be used with the present invention. While any number of sources for fragrances may be used, a particular source for a wide variety of fragrances is International Flavors and Fragrances, Inc., New York, N.Y. 10019.

The fragrances of Table 1 and the flavors of Table 2 are listed from information of such fragrances and flavors available on the website of International Flavors and Fragrances, Inc. Many of the fragrances and flavors in Table 1 and Table 2 have names that may be used in commercial context by International Flavors and Fragrances, Inc. Many others are listed as their chemical names. A detailed list of such fragrances and flavors is included in this application to underscore the versatility of this invention, in that the concept of this invention is applicable to those aromas that can be incorporated into a suitable adhesive.

TABLE 1
Fragrance Ingredients

| | |
|---|---|
| Abbarome ™ 011 | Citrus, Herbal, Fresh |
| Acalea | Floral, Mimosa, Jasmin |
| Allyl Amyl Glycolate | Fruity, Green, Galbanum, Pineapple |
| Ambrettolide | Musk, Sweet, Floral |
| Amyl Cinnamic Aldehyde | Floral, Jasmin, Waxy |
| Amyl Phenyl Acetate | Balsamic, Chocolate, Honey |
| Amyl Salicylate | Herbal, Floral, Sweet, Green |
| Andrane | Woody, Dry, Patchouli, Ambergris |
| Anethole 21/22 | Herbal, Anisic, Sweet |
| Anethole USP | Herbal, Anisic, Sweet |
| Anethole USP | Sweet, Anisic |
| Aphermate | Herbal, Woody, Ozone (Fresh Air/Marine), Fruity |
| Apo Patchone | Floral, Camphoraceous, Rose, Lilac |
| Bacdanol ® | Woody, Sandalwood |
| Benzyl Butyrate | Fruity, Plum, Floral |
| Benzyl Propionate | Fruity, Sweet, Floral, Jasmin |
| Benzyl Salicylate | Balsamic, Sweet, Floral |
| Bicyclononalactone | Sweet, Nutty, Powdery |
| Bornafix ® | Warm, Woody, Dry, Amber |
| Canthoxal | Floral, Anisic, Balsamic, Spicy |
| Cashmeran ® | Musk, Woody, Spicy, Floral |
| Cassiffix ® | Fresh, Herbal, Fruity, Cassis |
| Cedramber ® | Woody, Ambergris, Dry |
| Cedrenyl Acetate | Woody, Cedar, Vetivert |
| Celestolide | Musk, Animal |
| Cinnamalva | Spicy, Fatty, Cinnamon |
| Citral Dimethyl Acetal | Citrus, Lemon, Earthy |
| Citralva ® | Citrus, Lemon, Fatty, Aldehydic |
| Citronalva | Citrus, Lemon, Aldehydic, Metallic |
| Citronellol 700 JAX | Clean, Fresh, Rose |
| Citronellol 750 | Rose, Geranium |
| Citronellol 950 | Clean, Rose |
| Citronellol Coeur | Floral, Rose, Petal, Waxy |
| Citronellyl Acetate A | Sweet, Floral, Rose |
| Citronellyl Acetate Coeur | Fruity, Floral, Rose |
| Citronellyl Acetate Pure | Sweet, Fruity, Rose |
| Citronellyl Formate | Fruity, Floral, Rose, Leafy |
| Clarycet | Herbal, Clary Sage, Floral, Fruity |
| Clonal | Citrus, Zesty/Peely (Citrus), Fatty, Herbal |
| Coniferan | Woody, Herbal, Fruity, Pine |
| Cyclabute | Fruity, Herbal, Sweet, Balsamic |
| Cyclacet ® | Fruity, Green, Woody |
| Cyclaprop ® | Fruity, Herbal, Woody |
| Cyclemone A | Ozone (Fresh Air/Marine), Fruity, Woody, Herbal |
| Cyclobutanate | Fruity, Woody |
| Cyclogalbaniff ™ | Green, Galbanum, Fruity, Pineapple |
| Cyclohexyl Ethyl Acetate | Fruity, Balsamic, Green, Plum |
| Cyclohexyl Ethyl Alcohol | Floral, Green, Muguet, Minty |
| Damascol 4 | Floral, Woody, Spicy |
| Decyl Methyl Ether | Aldehydic, Fatty, Ozone (Fresh Air/Marine) |
| Delta Damascone | Fruity, Cassis, Floral, Woody |
| Dihydro Cyclacet | Herbal, Green, Fruity, Basil |
| Dihydro Floralate | Floral, Woody, Fruity, Grapefruit |
| Dihydro Floralol | Floral, Minty, Hyacinth, Woody |
| Dihydro Myrcenyl Acetate | Citrus, Bergamot, Floral, Lavender |
| Dihydro Terpineol | Floral, Citrus, Lime, Pine |
| Dihydro Terpinyl Acetate | Herbal, Fruity, Woody, Pine |
| Dihydro Terpinyl Acetate DSA | Woody |
| Dimethyl Benzyl Carbinol | Floral, Rose, Green, Oily |
| Dimethyl Benzyl Carbinyl Acetate | Fruity, Floral, Jasmin, Herbal |
| Dimethyl Benzyl Carbinyl Butyrate | Fruity, Plum, Sweet |
| Dimethyl Cyclormol | Woody, Patchouli, Camphoraceous, Herbal |
| Dimethyl Octanol | Waxy, Rose |
| Dimethyl Phenyl Ethyl Carbinyl | Floral, Fruity, Sweet, Balsamic |
| Acetate | |
| Dimyrcetol | Citrus, Herbal, Ozone (Fresh Air/Marine), Lime |
| Diola | Floral, Lavender, Herbal, Fruity |
| Dipentene 5100 | Pine, Lime, Citrus |
| Dulcinyl ® Recrystallized | Fruity, Sweet, Raspberry |
| Ethyl Ortho Methoxy Benzoate | Floral, Ylang, Tuberose, Fruity |
| Ethyl Phenyl Glycidate | Fruity, Strawberry, Sweet |
| Fleuramone | Floral, Jasmin, Fruity, Waxy |
| Fleuranil | Herbal, Anisic, Ozone (Fresh Air/Marine) |
| Floralate | Citrus, Fruity, Grapefruit, Dry |
| Floralol | Floral, Green, Spicy, Minty |
| Floralozone | Floral, Aldehydic, Ozone (Fresh Air/Marine), Muguet |
| Fraistone | Fruity, Apple Fruity, Strawberry, Sweet |
| Fructone | Fruity, Apple Fruity, Woody, Pine |
| Galaxolide ® 50 BB | Musk, Floral, Woody, Sweet |
| Galaxolide ® 50 DEP | Musk, Sweet, Floral, Woody |
| Galaxolide ® 50 DPG | Musk, Floral, Woody, Sweet |
| Galaxolide ® 50 IPM | Musk, Floral, Woody, Sweet |
| Galbanum Coeur | Green, Herbal, Galbanum, Balsamic |
| Gelsone | Floral, Jasmin, Waxy |
| Geraldehyde | Citrus, Aldehydic, Ozone (Fresh Air/Marine), Floral |
| Geraniol 5020 | Clean, Rose |
| Geraniol 7030 | Clean, Rose, Floral |
| Geraniol 980 Pure | Dry, Rose, Petal |
| Geraniol Coeur | Floral, Rose, Oily, Green |
| Geranyl Acetate A | Sweet, Rose, Lavender |
| Geranyl Acetate Extra | Sweet, Rose, Lavender |
| Geranyl Acetate Pure | Sweet, Fruity, Rose |
| Grisalva | Animal, Ambergris, Leather, Earthy |
| Helional ® | Floral, Green, Aldehydic, Ozone (Fresh Air/Marine) |
| Herbac | Herbal, Woody, Minty, Camphoraceous |
| Hexalon | Woody, Fruity, Pineapple, Floral |
| Hexenyl Salicylate, cis-3 | Green, Floral, Balsamic, Sweet |
| Hexyl Acetate | Fruity, Green, Pear |
| Hexyl Cinnamic Aldehyde | Floral, Jasmin, Waxy |
| Hexyl Salicylate | Floral, Herbal, Green |
| Hyacinth Body | Floral, Herbal, Green, Hyacinth |
| Hyacinth Body No. 3 | Floral, Herbal, Green, Sweet Pea |
| Hydratropic Aldehyde Dimethyl Acetal | Floral, Hyacinth, Green, Mushroom |
| Hydroxyol | Oily, Balsamic, Fatty |
| Hypo-Lem | Citrus, Aldehydic, Lemon |
| Indolarome | Floral, Animal, Earthy, Jasmin |
| Indolene 50 | Floral, Animal |
| Intreleven Aldehyde | Aldehydic, Floral, Ozone (Fresh Air/Marine), Citrus |
| Intreleven Aldehyde Special | Aldehydic, Floral, Ozone (Fresh Air/Marine), Citrus |
| Ionone 100% | Floral, Violet, Woody |
| Ionone Alpha | Floral, Violet, Woody, Fruity |
| Ionone Alpha Beta Regular | Violet, Woody, Fruity, Powdery |
| Ionone Beta | Woody, Dry, Fruity, Raspberry |
| Iso Amyl Butyrate | Fruity, Banana |
| Iso Amyl Salicylate | Sweet, Balsamic |
| Iso Bornyl Propionate | Pine, Herbal, Woody |
| Iso Butyl Phenyl Acetate | Floral, Narcisse, Leafy |
| Iso Butyl Quinoline | Leather, Animal, Herbal, Green |
| Iso Cyclemone E | Woody, Floral, Amber |
| Iso Cyclo Citral | Green, Aldehydic, Herbal, Leafy |
| Iso Cyclo Geraniol | Floral, Spicy, Woody, Carnation |
| Iso E Super ® | Woody, Floral, Ambergris |
| Isoproxen | Herbal, Citrus, Anisic, Animal |
| Jasmal | Floral, Herbal, Jasmin, Mushroom |
| Jasmelia | Floral, Jasmin, Waxy |
| Jessemal ® | Floral, Jasmin, Mushroom, Waxy |
| Kharismal ® | Floral, Jasmin, Lactonic |
| Koavone ® | Woody, Balsamic, Pine, Floral |
| Kohinool ® | Woody, Amber, Dry, Vetivert |
| Lavonax | Balsamic, Labdanum, Myrrh |
| Lemsyn | Citrus, Lemon, Green |
| Liffarome ™ | Green, Floral, Violet, Fruity |
| Lindenol ™ | Clean, Sweet, Lilac |
| Lyral ® | Floral, Muguet, Aldehydic, Woody |
| Lyrame | Floral, Muguet |
| Lyrame Super | Floral, Muguet |
| Maritima | Ozone (Fresh Air/Marine), Woody, Leather, Animal |
| Meijiff ™ | Floral, Muguet |
| Melafleur | Floral, Muguet, Ozone (Fresh Air/Marine), Fruity |
| Methyl Anthranilate | Fruity, Grape, Floral, Orange Flower |
| Methyl Cedryl Ketone Chinese | Woody, Leather, Vetivert |
| Methyl Cinnamic Aldehyde alpha | Spicy, Cinnamon |
| Methyl Ionone Gamma A | Woody, Floral, Violet, Dry |
| Methyl Ionone Gamma Coeur | Woody, Floral, Violet |
| Methyl Ionone Gamma Pure | Woody, Floral, Violet, Dry |
| Methyl Lavender Ketone | Floral, Herbal, Lavender, Sweet |
| Montaverdi ® | Fresh, Green |
| Muguesia | Floral, Muguet, Rose, Minty |
| Muguet Aldehyde 50 | Floral, Aldehydic, Ozone (Fresh Air/Marine), Muguet |
| Muguet Aldehyde 50 BB | Floral, Aldehydic, Ozone (Fresh Air/Marine), Muguet |
| Myrac Aldehyde | Citrus, Aldehydic, Floral, Ozone (Fresh Air/Marine) |
| Myrcenol Super | Fresh, Citrus |
| Myrcenyl Acetate | Citrus, Bergamot, Floral, Lavender |
| Neoproxen | Herbal, Leafy, Green, Citrus |
| Nerol 800 | Sweet, Fresh, Citrus, Rose |
| Nerol 850 | Sweet, Citrus, Rose, Fresh |
| Nerol 900 | Sweet, Citrus, Rose, Fresh |
| Neryl Acetate JAX | Sweet, Floral, Citrus, Rose |
| Ocimene | Citrus, Lime, Pine |
| Ocimenyl Acetate | Citrus, Bergamot, Floral, Lavender |
| Octacetal | Citrus, Green, Earthy, Ozone (Fresh Air/Marine) |
| Orange Flower Ether | Citrus, Grapefruit, Floral, Orange Flower |
| Orivone | Woody, Orris, Camphoraceous |
| Orriniff ™ 25% IPM | Floral, Violet, Orris, Leather |
| Oxaspirane | Herbal, Minty, Camphoraceous, Lavender |
| Ozofleur | Green, Floral, Ozone (Fresh Air/Marine), Fruity |
| Pamplefleur ® | Citrus, Grapefruit, Floral, Vetivert |
| Peomosa | Floral, Rose, Mimosa |
| Phenafleur ® | Floral, Hyacinth, Fruity, Balsamic |
| Phenoxanol ® | Floral, Rose |
| Phenoxyethyl Iso Butyrate | Fruity, Floral, Rose, Honey |
| Phenoxyethyl Propionate | Fruity, Balsamic, Myrrh |
| Phenyl Ethyl Acetate | Fruity, Floral, Rose, Leafy |
| Phenyl Ethyl Alcohol | Floral, Hyacinth, Rose, Green |
| Phenyl Ethyl Benzoate | Balsamic, Floral, Rose |
| Phenyl Ethyl Formate | Floral, Hyacinth, Green, Herbal |
| Phenyl Ethyl Iso Butyrate | Fruity, Floral, Sweet, Tea |
| Phenyl Ethyl Phenyl Acetate (USDEA) | Balsamic, Floral, Honey, Sweet |
| Phenyl Ethyl Salicylate | Balsamic, Floral, Rose |
| Piconia | Woody, Patchouli, Earthy, Camphoraceous |
| Precyclemone B | Ozone (Fresh Air/Marine), Aldehydic, Floral, Muguet |
| Prenyl Acetate | Fruity, Pear, Green |
| Proflora | Fruity, Balsamic, Chocolate, Ylang |
| Pseudo Linalyl Acetate | Citrus, Bergamot, Floral, Lavender |
| Reseda Body | Floral, Hyacinth, Green, Balsamic |
| Rosalva | Floral, Aldehydic, Rose, Waxy |
| Rosamusk | Floral, Musk, Geranium, Fruity |
| Roseate | Floral, Rose, Waxy, Aldehydic |
| Rosemarel | Herbal, Camphoraceous |
| Salicynalva | Balsamic, Clover, Styrax |
| Sanjinol | Sandalwood, Floral, Woody |
| Santaliff ™ | Sandalwood |
| Spirodecane | Herbal, Eucalyptus, Woody |
| Strawberiff ® | Fruity, Strawberry, Woody |
| Styralyl Propionate | Floral, Green, Fruity, Kiwi |
| Syvertal | Green, Fruity, Floral, Chrysanthemum |
| Terpineol 900 | Clean, Lilac, Pine |
| Terpineol Alpha JAX | Lilac, Citrus |
| Terpineol Extra | Floral, Lilac, Citrus, Lime |
| Terpinolene 20 | Pine, Citrus |
| Terpinolene 90 | Pine, Lime, Citrus |
| Terpinolene 90 PQ | Dry, Citrus |
| Terpinyl Acetate Extra | Sweet, Herbal, Bergamot, Lavender |
| Terpinyl Acetate JAX | Sweet, Herbal, Bergamot, Pine |
| Tetrahydro Muguol ® | Floral, Woody, Citrus |
| Tetrahydro Muguol ® Coeur | Floral, Citrus, Woody |
| Tetrahydro Myrcenol | Citrus, Lime, Sweet, Juicy |
| Tetrameran | Floral, Green, Balsamic, Woody |
| Tobacarol | Woody, Amber, Spicy, Tobacco |
| Trimofix ® O | Woody, Ambergris, Musk, Vetivert |
| Triplal ® | Green, Citrus, Herbal, Aldehydic |
| Triplal ® Extra | Green, Citrus, Herbal, Aldehydic |
| Unipine ® 60 | Pine |
| Unipine ® 75 | Pine |
| Unipine ® 80 | Pine |
| Unipine ® 85 | Pine |
| Unipine ® 90 | Pine |
| Unipine ® NCL | Pine |
| Unipine ® S —70 | Pine |
| Vandor ® B | Aldehydic, Green, Citrus, Fatty |
| Vanoris | Fruity, Woody |
| Verdol | Pine, Camphoraceous, Minty, Patchouli |
| Verdox ™ | Fruity, Woody, Apple Fruity, Herbal |
| Verdox ™ HC | Fruity, Apple Fruity, Woody, Herbal |
| Verdural B Extra | Green, Fruity, Apple Fruity |
| Verdural Extra | Green, Fruity, Grass |
| Vertenex ® | Woody, Floral, Fruity |
| Vertenex ® HC | Woody, Floral, Balsamic, Fruity |
| Vertofix ® Coeur | Woody, Vetivert, Leather, Musk |
| Vigoflor | Citrus, Grapefruit, Vetivert, Floral |
| Violiff | Floral, Violet, Banana |

In addition, the flavors listed in Table 2 can be used with the present invention. While any number of sources for flavors may be used, a particular source for a wide variety of flavors is International Flavors and Fragrances, Inc., New York, N.Y. 10019.

TABLE 2
Flavor Ingredients

4,5-Dimethyl-2-ethyl-3-thiazoline
6-Methyl Coumarin
Allyl Caproate
Anethole USP
Asafoetida Oil English Distilled SAS
Black Pepper Oil
Buchu Sulfur Fractions
Butyric Acid
Cardamon Oil English Distilled SAS
Cassia Oil
Cassia Oil Redistilled
Cinnamon Bark Oil
Cinnamon Leaf Oil Cleaned
Clove Bud Oil English Distilled SAS
Clove Leaf Oil Redistilled
Cocal ™
Cocoa Distillate (Nat.)
Cocoa Essence Dark
Cocoa Essence White
Coffee Enhancer Base
Coffee Enhancer W/S
Coffee Extract
Coffee Extract Italian Roast M3881 Nat.
Coffee Extract Nce liim Nat.
Coffee Extract Nce Iv Nat.
Coriander Oil
Cyclodithalfarol-705
delta Decalactone
Dimethyl Benzyl Carbinyl Butyrate
Dimethyl Sulfide
Dithione 865
Ethyl-2-Methyl Butyrate
Ethyl-3-Hydroxy Butyrate
Ethyl Butyrate
Ethyl Iso Butyrate
Ethyl Iso Valerate
Ethyl Oxanoate 369
Eucalyptus Oil 80%
Farnesene 1% PG/ETOH
Furfurrole 302
gamma-Decalactone
gamma-Hexalactone
gamma-Octalactone
gamma Dodecalactone
Ginger Oil Chinese
Ginger Oil Nigerian English Distilled SAS
Grapefruit Key
Grill Flavor O/S
Grill Flavor W/D
Heptan-2-One (Nat.)
Hexene-3-One-4
Hexyl Acetate
Homo Cyclocitral, beta
Honey Distillate Nat.
Ionone Beta
Iso Amyl Iso Valerate
Iso Butyl Caproate
Iso Butyl Furyl Propionate
Iso Fragarone-030
Iso Fragarone, 1% ETOH ™
Isovaleric Acid
Juniperberry Oil English Distilled SAS
Ketone Mix
Kumarone ™
Lemon Oil 5X Sas
Lemon Oil Terpeneless Sas
Lemonless Lemon Key
Lime Oil Terpeneless
Linalool
Linalyl Acetate (Nat.)
Mangone 5% ETOH ™
Methional
Methyl Butyric Acid (2)
Methyl Ketones (Nat.)
Methyl Oxycyclosulfide 719
Mushroom Extract
Natural Flavor (99% Vanillin)
Nat. Cocoa Butter Distillate
Nat. Peanut Distillate
Nonan-2-One (Nat.)
Nutmeg Oil East Indian
Octanal 35% (Nat.)
Octen-4-one-2
Olibanum Oil English Distilled SAS
Orange Oil 15X Decolorized M3706
Orange Oil 950 (10X)
Orange Oil Terpeneless 2501
Oxaromate-884
Oxycyclothione-030
Paradiff ™ 0.01% ETOHGR
Paradiff ™ 0.01% Grapefruit Oil
Peach Flavor Key
Peppermint Oil Redistilled Yakima
Peppermint Oil Spec. Fractions
Phenyl Ethyl 2-Methyl Butyrate
Phenyl Ethyl Acetate
Phenyl Ethyl Alcohol
Phenyl Oxaromate-681
Pimento Berry Oil English Distilled SAS
Pimento Leaf Oil
Pimento Leaf Oil Cleaned
Pineapple Compound 15% ETOH GR
Pineapple Compound 15% PG
Popcorn Chemical
Propionic Acid
Raspberry Flavor Key
Robustone 1.0% ETOH ™
Robustone ™
Schinus Molle Oil
Sclareolide
Sesame Distillate Nat.
Sinensals (Nat.)
Starter Distillate 15X W/S
Strawberriff
Strawberry Base
Strawberry Flavor Key
Succinic Acid
Sulfurome-015
Sweetness Modifier
Tetrahydro Terrazine-014 ™
Thionol-935
Thionol-966
trans-2-Hexenal
Trimenal Acetate 399 1% ETOH ™
Tropical Fruit Key Base
Undecan-2-One (Nat.)
Varamol-106 10% ETOH
Varamol-106 10% NEBM5
Varamol-106 10% PG

Preparation of a Web or Film

Generally, a web in its final form is a composite film of biaxially-stretched plurality of film layers. Film forming and drawing to effect biaxial orientation can be carried out by conventional techniques, i.e. the well-known tubular (bubble) process or the equally well-known tenter process. When the webs are prepared by the bubble process, the draw is effected simultaneously and uniformly in the machine and cross directions to about 3 times to 9 times and preferably about 5 times to 8 times. Using the tenter process, drawing is carried out sequentially to about 3 times to 9 times in the machine direction and to about 7 times to 11 times in the cross direction.

The biaxially-oriented multi-film web may then be subjected to a heat setting treatment.

Functional layers that can be employed as the skin layer include such layers as a heat seal layer. Such a layer will be of a material of lower softening point than the core so that when heat is applied to effect the seal, the core layer will not be disturbed. A commonly used heat seal layer is a terpolymer of propylene, ethylene and butene-1. Other polymers that can be employed as a heat seal layer include polyethylene, copolymers of propylene and ethylene, copolymers of butene and ethylene, copolymers of butene and propylene, polyvinylidene chloride and mixtures thereof.

Another commonly used functional layer is a slip layer to facilitate handling of the film during later converting operations. Such a layer is comprised of a polymer containing a slip agent such as a high molecular weight fatty acid amide. A functional layer may also contain an antiblock additive to facilitate unwinding of the film after it has been wound at the terminus of the film manufacturing process. Such layers can be made of the same heteropolymer blend as is employed in the core layer. A slip layer can also be comprised of polypropylene.

Polypropylene skins can also be employed to provide printable surfaces to the webs of the invention by subjecting the skins to an oxidative medium according to known methods. A preferred oxidative medium is corona discharge. Another preferred oxidative technique is flame treatment. One skilled in the film art can readily determine the degree of oxidative treatment required for a particular application.

Composite films can be prepared by coextrusion, lamination or extrusion coating. All of these techniques are well known in the film art.

### EXPERIMENTAL

To demonstrate the concept of preparing film packaging laminates with controlled release of an aroma additive, a series of laminates were prepared where the additive was introduced into the adhesive layer of the laminate. In examples 1-4, films of varied compositions, known to exhibit different oxygen and moisture barrier characteristics, were laminated to a web of 48 ga polyester (oriented PET).

The laminates were prepared with a pressure sensitive adhesive containing about 2% d-limonene. In common practice, the web to which the adhesive is applied to is defined as the primary web and the web placed against the dried adhesive is defined as the secondary web. Transmission of the d-limonene from the adhesive through the secondary web was determined by a exposing the face of the secondary web to a sampling vial.

After a predetermined heat exposure to accelerate the d-limonene permeation, the headspace of the vial was analyzed by gas chromatography. Given a constant heat exposure, headspace volume and vial sampling volume, the area (integrated count) of the gas chromatograph elution peak is proportional to the d-limonene concentration in the vial headspace. The GC headspace results for the four examples appear in TABLE 3.

For Examples 1-4, the transmission of the d-limonene into the vial headspace followed a trend consistent with the oxygen permeability of the secondary webs. The polyester web of Example 1 exhibited less transmission than the PVdC coated web of Example 2. The high-isotacticity homopolymer web of Example 3 had a higher oxygen permeability than that of Example 2. The low-tacticity polymer blend of Example 4 exhibited the highest d-limonene transmission.

In Examples 5-11 polyethylene extrusion laminations were prepared with LDPE (low-density polyethylene) compounded with 0.5% d-limonene. In these examples, the primary and secondary webs had the same film composition. For these samples the primary web is defined as the web contacting the extrusion-laminating chill roll. It is also the web that the LDPE initially contacts. The secondary web is defined as the film that is placed on to the extruded LDPE prior to nipping the webs together. Transmission of the d-limonene through the laminations was measured as described for Examples 1-4. The results are given in TABLE 4.

As noted for the adhesive laminations in Examples 1-4, the polyethylene extrusion laminations of Examples 5-11 also exhibit a trend of d-limonene transmission generally consistent with the oxygen permeability of the individual webs. The polyester, PVdC-coated and vacuum-metallized films all exhibited lower transmission of the d-limonene than the remaining BOPP (biaxially-oriented polypropylene) samples. For samples 8-11 the permeability of the d-limonene was consistent with the lower isotacticity of the polymer films.

It was noted that the transmission of d-limonene in Example 7, where the webs were a vacuum-metallized aluminum BOPP film, was higher than that for Example 6 where the webs were a PVdC-coated BOPP film. This result was contrary to the anticipated oxygen permeability of the two films. Upon further investigation, it was determined that the metallized surface of the films in Example 7 had been damaged during the extrusion laminating process. To those familiar with the laminating process, the defect would be recognized as metal crazing. This defect is known to result in deterioration of the oxygen barrier property of the web.

In Examples 12-14, film webs exhibiting different d-limonene transmission characteristics (as demonstrated in Examples 5, 6, 9 and 11) were combined in polyethylene extrusion laminations. For Example 12, the secondary web of Example 5 was replaced with the secondary web from Example 11. For Example 13, the secondary web of Example 6 was replaced with the secondary web from Example 11. Finally, for Example 14, the secondary web of Example 9 was replaced with the secondary web from Example 11. The laminations were tested as described above. However, for these samples, the d-limonene transmission through the primary web was also measured. The results are given in TABLE 5.

The transmission of d-limonene in Example 12 was consistent with trends from the previous examples with these two film webs. A high concentration of d-limonene permeated the secondary web but no measurable d-limonene permeated the primary polyester web.

In Examples 13 and 14, a high, but slightly reduced transmission of d-limonene was measured through the secondary web. However, a higher than anticipated (based upon testing of Examples 6 and 9) amount of d-limonene was measured in the headspace of the vial when the primary web was placed against the sampling vial. Upon further investigation, it was determined when the laminate was stored as a roll, transmission of the d-limonene through the highly permeable secondary web migrated into the exposed surface of the primary web, thus increasing the d-limonene content in the primary web. This was demonstrated by placing a sheet of the primary film web (free of d-limonene) against a cast film sheet of LDPE containing about 0.5% d-limonene and blocking the two sheets at 50 psi for 18 hours. The surface of the primary sheet that had been contacting the LDPE sheet was analyzed by headspace GC as was found to contain a high concentration of d-limonene.

### EXAMPLES

### Example 1

A two film web adhesive lamination was prepared by coating a primary web of 48 ga polyester film with a pressure sensitive adhesive and adhering it to a secondary web of 48 ga polyester film. The pressure sensitive adhesive Robond PS9208 from Rohm & Haas Co. (Rohm and Haas Company, Philadelphia, Pa.), was modified by mixing in a 75% solution of d-Limonene in isopropanol, resulting in a final d-limonene concentration of 2% in the adhesive. The modified adhesive was applied to the primary web of polyester through a No. 20 Meyer rod and the adhesive was dried at 50° C. for 2 min. The resulting dry coat weight was 5.8 lbs/ream. The secondary web of polyester was laminated to the adhesive-coated primary web through a 2.0 lb laminating roller.

The permeability of the d-limonene through the secondary web was determined by placing the web surface against the mouth of a 20 mil sampling vial fitted with a septum cap. The vial was stored at 90° C. for 10 min and the vial headspace was analyzed by a gas chromatograph equipped with a flame ionization detector.

### Example 2

A two-film web adhesive lamination was prepared from a primary web of 48 ga polyester film and a secondary web of 65 ga biaxially-oriented polypropylene (BOPP) film. The film surface was coated with a PVdC to provide enhanced oxygen and moisture barrier. An example is the commercially available film UBP (from AET Films, New Castle, Del.). In this example the PVdC coated surface was placed in contact with the pressure sensitive adhesive. The laminate sample was prepared and tested as described in Example 1.

### Example 3

A two film web adhesive lamination was prepared from a primary web of 48 ga polyester film and a secondary web of 48 ga biaxially-oriented polypropylene (BOPP) film. The web surface was produced with a high-tacticity polypropylene homopolymer core and two high-tacticity homopolymer skins. An example is the commercially available film B503-2 (from AET Films, New Castle, Del.). The laminate sample was prepared and tested as described in Example 1.

### Example 4

A two film web adhesive lamination was prepared from a primary web of 48 ga polyester film and a secondary web of an experimental 55 ga biaxially-oriented polypropylene (BOPP) film. The film core was prepared as a 60:40 blend of high-tacticity homopolymer of polypropylene and a low-tacticity ethylene-propylene random copolymer containing about 4% ethylene. The reduced isotacticity of the core blend was designed to provide oxygen and moisture permeability to d-limonene from the pressure sensitive adhesive. The laminate sample was prepared and tested as described in Example 1.

### Example 5

A two-web polyethylene extrusion lamination was prepared from a primary web of 48 ga polyester and a secondary web of 48 ga polyester. The polyethylene extrudate (Chevron 1017 LDPE) was modified by first preparing a master batch of LDPE that was surface coated with d-limonene. The master batch was then dry blended with unmodified LDPE and homogenized in a laboratory twin-screw extruder. The final concentration of the d-limonene in the LDPE was determined to be 0.5% as measured by gas chromatography.

The extrusion lamination was conducted on a Faustel laminator at a web speed of 300 ft/min and an extrusion temperature of 300° C. The LDPE was applied at a coat weight of 8 lbs/ream. The permeability of d-limonene through the secondary web was determined by placing the web surface against the mouth of a 20 mil sampling vial fitted with a septum cap. The vial was stored at 90° C. for 10 min and the vial headspace was analyzed by a gas chromatograph equipped with a flame ionization detector.

### Example 6

A two-web extrusion lamination was prepared from a primary web of 65 ga biaxially-oriented polypropylene film and a secondary web of the same 65 ga film. The surface of BOPP film layer forming the primary and secondary webs was coated with a PVdC to provide enhanced oxygen and moisture barrier. An example is the commercially available film (web) UBS-2 (from AET Films, New Castle, Del.). In this example, the PVdC coated surface was placed in contact with the extrusion laminating polymer. The laminate sample was prepared and tested as described in Example 5.

### Example 7

A two-web extrusion lamination was prepared from a primary web of 55 ga biaxially-oriented polypropylene film and a secondary web of the same 55 ga film. The surface of BOPP film layer forming the primary and secondary webs was vacuum-metallized with aluminum to provide enhanced oxygen and moisture barrier. An example is the commercially available film MXT (from AET Films, New Castle, Del.). In this example, the metallized surface was placed in contact with the extrusion laminating polymer. The laminate sample was prepared and tested as described in Example 5.

### Example 8

A two-web extrusion lamination was prepared from a primary web of 55 ga biaxially-oriented polypropylene film and a secondary web of the same 55 ga film. The film surface was produced with a high tacticity polypropylene homopolymer core and two high tacticity homopolymer skins (both webs). An example is the commercially available film B503-2 (from AET Films, New Castle, Del.). The laminate sample was prepared and tested as described in Example 5.

### Example 9

A two-web extrusion lamination was prepared from a primary web of 60 ga biaxially oriented polypropylene film and a secondary web of the same 60 ga film. The film surface was produced with a medium tacticity polypropylene homopolymer core and skin and a ethylene propylene random copolymer skin. An example is the commercially available film RLS (from AET Films, New Castle, Del.). The laminate sample was prepared and tested as described in Example 5.

### Example 10

A two-web extrusion lamination was prepared from a primary web of 55 ga biaxially-oriented polypropylene film and a secondary web of the same 55 ga film. The experimental film contains a 60:40 blend of high- and low-tacticity homopolymer polypropylene and two ethylene-propylene random copolymer skins. The film was designed to provide increased oxygen and moisture permeability. The laminate sample was prepared and tested as described in Example 5.

### Example 11

A two film web extrusion lamination was prepared from a primary web and a secondary web, both of which are made from 55 ga BOPP film. The film core was prepared as a blend of high-tacticity homopolymer polypropylene and a low-tacticity ethylene-propylene random copolymer. The reduced isotacticity of the core blend was designed to provide oxygen and moisture permeability of the film web. An example is the commercially available film HOTR (from AET Films, New Castle, Del.). The laminate sample was prepared and tested as described in Example 5.

### Example 12

A two-web extrusion lamination was prepared from a primary web of 48 ga polyester film as described in Example 5, and a secondary web of 55 ga HOTR film as described in Example 11. The laminate sample was prepared and tested as described in Example 5, except the permeation through both the secondary and primary webs were each individually measured.

### Example 13

A two-web extrusion lamination was prepared from a primary web of 65 ga UBS-2 film as described in Example 6, and a secondary web of the 55 ga HOTR film as described in Example 11. The laminate sample was prepared and tested as described in Example 5, except the permeation through both the secondary and primary webs were each individually measured.

### Example 14

A two-web extrusion lamination was prepared from a primary web of 60 ga RLS film as described in Example 9, and a secondary web of the 55 ga HOTR film, as described in Example 11. The laminate sample was prepared and tested as described in Example 5, except the permeation through both the secondary and primary webs were each individually measured.

TABLE 3

| Laminate | | |
|---|---|---|
| Primary Substrate | | Area Count |
| Example 1 | Avg. | No Detection |
| | Std. Dev. | — |
| Example 2 | Avg. | 95 |
| | Std. Dev. | 30 |
| Example 3 | Avg. | 11,100 |
| | Std. Dev. | 1,680 |
| Example 4 | Avg. | 28,300 |
| | Std. Dev. | 7,130 |

TABLE 4

| | Secondary | D-Limonene in GC | |
|---|---|---|---|
| Example | Web | headspace area counts | Primary Web |
| 5 | 48 ga PET | None detected | 48 Ga. PET |
| 6 | 65UBS-2 | 2,280 counts avg | 65UBS-2 |
| | | 3,200 std dev | |
| 7 | 55. MXT | 17,500 counts avg | 55 MXT |
| | | 5,500 std dev | |
| 8 | 48 B503-2 | 30,200 counts avg | 48B503-2 |
| | | 3,600 std dev | |
| 9 | 60 RLS | 35,700 counts avg | 60 RLS |
| | | 2,100 std dev | |
| 10 | 55 Ga | 45,400 counts avg | 55 Ga. Experimental |
| | Experimental | 11,900 std dev | |
| 11 | 55 HOTR | 66,200 counts avg | 55 HOTR |
| | | 5,700 std dev | |

TABLE 5

| | Secondary Web | Primary Web |
|---|---|---|
| Example 12 | HOTR | Polyester |
| Average | 70,000 | No Detection |
| Std. dev | 4,910 | — |
| Example 13 | HOTR | UBS-2 |
| Average | 49,800 | 23,800 |
| Std. dev | 3,930 | 8,670 |
| Example 14 | HOTR | RLS |
| Average | 54,200 | 52,300 |
| Std. Dev. | 3,950 | 2,750 |

What is claimed is:

1. A laminated structure used for flexible packaging material, comprising:
(a) a first web;
(b) a second web; and
(c) an adhesive layer positioned between and in contact with said first web and said second web, said adhesive layer comprising a bonding material and at least one aroma generating substance;
wherein said first web's permeability of said aroma generating substance is greater than said second web's permeability of said aroma generating substance.

2. The laminated structure recited in claim 1, wherein said aroma generating substance permeates out from said laminated structure in one direction.

3. The laminated structure recited in claim 1, wherein said bonding material in said adhesive layer is selected from the group consisting of extrusion-laminating adhesive, water-borne adhesive, solvent-borne adhesive, radiation-curable adhesive, multiple-part reactive adhesive, and mixtures thereof.

4. The laminated structure recited in claim 1, wherein said first web and/or said second web comprises at least one film layer, said film layer comprising polymeric compound selected from the group consisting of polyethylene, polypropylene, polybutylene, copolymers of propylene with ethylene, copolymers of propylene with butene-1, copolymers of butene-1 with ethylene, copolymers of ethylene and butylene, terpolymers of propylene-ethylene-butylene, cyclic olefins, styrene-butadiene copolymer, polystyrene, polyester, polyamide, and ionomers.

5. The multi-layered structure recited in claim 4, wherein said first web and/or said second web comprises a biaxially oriented polypropylene film.

6. A process for preparing a flexible packaging material capable of releasing aroma, comprising:
(a) providing a first web;
(b) providing a second web; and
(c) providing an adhesive layer positioned between and in contact with said first web and said second web, said adhesive layer comprising a bonding material and at least one aroma generating substance;
wherein said first web's permeability of said aroma generating substance is greater than said second web's permeability of said aroma generating substance.

7. The process recited in claim 6, wherein said aroma generating substance permeates out from said laminated structure in one direction.

8. The process recited in claim 6, wherein said bonding material in said adhesive layer is selected from the group consisting of extrusion-laminating adhesive, water-borne adhesive, solvent-borne adhesive, radiation-curable adhesive, multiple-part reactive adhesive, and mixtures thereof.

9. The process recited in claim 6, wherein said first web and/or said second web comprises at least one film layer, said film layer comprising polymeric compound selected from the group consisting of polypropylene, polyethylene, copolymers of propylene with ethylene, copolymers of propylene with butene-1, polystyrene, polyester, polyamide, and ionomers.

10. The multi-layered structure of claim 9, wherein said first web and/or said second web comprises a biaxially oriented polypropylene film.
